(19) United States
(12) Patent Application Publication
(10) Pub. No.: US 2025/0163197 A1
(43) Pub. Date: May 22, 2025

(54) SOLVENT-FREE COMPOSITIONS FOR MAKING POLYMER-BASED SOLID ELECTROLYTES OR CATHODES, POLYMERIC ELECTROLYTES OR ELECTRODES USING THE SAME, AND METHODS OF MAKING THE SAME

(71) Applicant: UIF ( UNIVERSITY INDUSTRY FOUNDATION ), YONSEI UNIVERSITY, Seoul (KR)

(72) Inventors: Sang-Young LEE, Seoul (KR); Kyeong-Seok Oh, Seoul (KR); Dong-Yeob Han, Seoul (KR); Jung Hyun Pang, Seoul (KR)

(73) Assignee: UIF ( UNIVERSITY INDUSTRY FOUNDATION ), YONSEI UNIVERSITY, Seoul (KR)

(21) Appl. No.: 18/949,038

(22) Filed: Nov. 15, 2024

(30) Foreign Application Priority Data
Nov. 16, 2023 (KR) 10-2023-0158946
Nov. 16, 2023 (KR) 10-2023-0158951

(51) Int. Cl. C08F 120/06; H01M 4/02; H01M 10/0565; H01M 10/0568

(52) U.S. Cl. CPC C08F 120/06; H01M 10/0565; H01M 10/0568; H01M 2004/028

(57) ABSTRACT

The present invention relates to a solvent-free composition for making a polymer-based solid electrolyte, an electrode using the composition, and a method for making the composition. The polymer electrolyte composition according to the present invention can exhibit excellent dispersibility without a process solvent, can solve problems caused by residual solvent, and can exhibit high oxidative stability.

### CROSS-REFERENCE TO RELATED APPLICATIONS

This application claims priority under 35 U.S.C. § 119 to Korean Patent Application Nos. 10-2023-0158946 and 10-2023-0158951 filed on Nov. 16, 2023 and Nov. 16, 2023, respectively in the Korean Intellectual Property Office, the disclosure of which is incorporated herein by reference in its entirety.

### BACKGROUND OF THE INVENTION

### Technology

The present invention relates to a solvent-free composition for the preparation of a polymeric solid electrolyte or cathode, a polymeric electrolyte or electrode utilizing the composition, and a method for preparing the same.

### Technology Behind the Invention

Recent developments in the advanced electronics industry have enabled miniaturization and lightweighting of electronic equipment, which has led to an increase in the use of portable electronic devices. In particular, secondary cellies composed of metal-oxygen, metal-air, other metal and gas mixtures, and all-solid-state batteries can have a theoretical specific energy that is three to five times higher than conventional batteries due to the atomic density and high reduction capacity caused by the low atomic number of lithium, for example, used as the metal. The need for batteries with high energy density to power portable electronic devices has increased, and research on lithium secondary cellies is actively underway.

A secondary cell, such as a lithium secondary cell or a supercapacitor, includes an anode and a cathode, and an electrolyte that separates said cathode from said anode, and through which ions are conducted. Types of said electrolyte include liquid electrolyte and solid electrolyte.

Liquid electrolytes have the advantage of high ionic conductivity due to the free movement of ions within the electrolyte. However, liquid electrolyte requires injection and wetting processes, which increases the process time excessively. In addition, liquid electrolyte can cause the internal pressure of the secondary cell to increase and risk leakage, and if the separator is damaged by deformation or external impact, it can cause a short circuit, which can lead to overheating or explosion.

As an alternative, all-solid-state batteries, which replace liquid electrolytes with solid electrolytes, are being developed, and these solid electrolytes are mainly polymer electrolytes based on polymers. Solid electrolytes based on polymers have the advantages of increasing the safety of the battery, improving the reliability of the battery by preventing leakage of the electrolyte, and making it easier to manufacture thin batteries. However, solid electrolytes have low ionic conductivity due to the crystallinity of the polymer and restrictions on the movement of ions due to the complex molecular chains, resulting in poor output characteristics at low temperatures. In addition, solid electrolytes have poorer surface adhesion to the active material compared to liquid electrolytes, resulting in increased interfacial resistance, and the solid electrolyte is distributed in a non-contact state with the electrode active material, resulting in a decrease in output characteristics and capacity characteristics compared to the amount of conductive material used. In addition, there are economic limitations due to the high cost of materials and the high temperature and pressure processes required. In particular, in polymer-based solid electrolytes such as PEO, binders have been required to be used due to low adhesion due to weak intermolecular interactions with the electrolyte, and the energy characteristics of the cell are degraded due to the introduction of binders.

Therefore, there is an urgent need to develop polymer electrolytes that are stable, have excellent electrochemical properties, and can be manufactured in a simple process, and binder-free electrodes using them.

### PRIOR ART

### Patent Literature

(Patent Reference 1) Patent Reference 1. Korean Registered Patent No. 10-2567762

### INVENTION DESCRIPTION

### The Problem You want to Solve

It is an object of the present invention to provide a solvent-free composition for the preparation of a polymeric solid electrolyte or electrode, the composition comprising a liquid monomer; and a lithium salt, wherein the lithium salt is included in an excess amount over the liquid monomer.

It is also an object of the present invention to provide a polymer-based electrolyte or cathode prepared by crosslinking a solvent-free composition for the preparation of said polymeric solid electrolyte or cathode.

It is also an object of the present invention to provide a secondary cell comprising said polymer-based electrolyte or said cathode or both.

It is also an object of the present invention to provide an apparatus comprising said secondary cell, said apparatus being wherein it is selected from the group consisting of a communication equipment, an energy storage system (ESS), and a transportation vehicle.

It is also an object of the present invention to provide a method for preparing a polymeric solid electrolyte comprising (A) obtaining a solvent-free composition for preparing a polymeric solid electrolyte comprising a liquid monomer and an excess of lithium salt; and (B) crosslinking said polymeric solid electrolyte.

It is also an object of the present invention to provide a method of manufacturing a cathode, comprising: (A) obtaining a solvent-free composition for manufacturing a cathode, the composition comprising a liquid monomer, an excess of lithium salt, a cathode active material, and a coating material; and (B) coating and crosslinking said solvent-free composition for manufacturing a cathode onto a substrate.

### Solution to the Challenge

One aspect of the present invention provides a solvent-free composition for making a polymeric solid electrolyte comprising a liquid monomer; and a lithium salt, wherein said lithium salt is included in an excess amount over said liquid monomer.

With respect to said 100 parts by weight of liquid monomer, said lithium salt may be from 120 to 350 parts by weight.

The liquid monomer may comprise one or more functional groups selected from the group of monomers comprising carbonyl groups, amine groups, epoxy groups, phenolic groups, urethane groups, and acrylate groups.

Examples of the above lithium salts include but are not limited to at least one selected from LiBOB, LiFOB, LiDFBP, Li(CF₃SO₂)₂, Li(CF₃SO₂)₂CH, Li(CF₃SO₂)₃C, LiCF₃(CF₂)₇SO₃, LiCF₃SO₃, LiCF₃CF₂SO₃, LiTFO, LiClO₄, LiSbF₆, LiAsF₆, LiPF₆, Li(CF₃)₂PF₄, Li(CF₃)₃PF₃, Li(CF₃)₄PF₂, Li(CF₃)5PF, Li(CF₃)₆P, LiCTFSI (LiN(C₂F₄S₂O₄)), LiBETI (LiC₄NO₄F₁₀S₂), LiFSI (LiNO₄F₂S₂) and LiTFSI (LiC₂NO₄F₆S₂).

The combination of said liquid monomer and said lithium salt (liquid monomer, lithium salt) may be at least one selected from the group consisting of (bisphenol A, LiBETI), (bisphenol F, LiFSI), (polyester polyol, LiTFSI), (Novalak, LiFSI), (polyether polyol, LiBETI), and (acrylic acid, LiTFSI).

Another aspect of the present invention provides a polymer-based electrolyte prepared by crosslinking said polymer-based electrolyte composition.

Another aspect of the present disclosure provides an electrode comprising: a solvent-free composition for making a polymer-based solid electrolyte; and an electrode active material.

The solvent-free composition for making said polymeric solid electrolyte may comprise from 9 to 23 wt %, based on 100 wt % of the total of said electrodes.

The electrode active material may comprise one or more species selected from the group consisting of LCO (LiCoO₂), NCM111 (LiNi_{1/3}Co_{1/3}Mn_{1/3}O₂), NCM622 (LiNi_{0.6}Co_{0.2}Mn_{0.2}O₂), NCM811 (LiNi_{0.8}Co_{0.1}Mn_{0.1}O₂), LMO (LiMn₂O₄) [symbol] LNMO (LiNi_{0.5}Mn_{1.5}O₄).

The electrode may further comprise a conductive material.

The coating material may comprise at least one type selected from the group consisting of Super P, Super C, carbon black, Ketjenblack, natural graphite, artificial graphite, carbon black, acetylene black, lamp black, furnace black, and summer black.

The solvent-free composition for making said electrode active material, said coating material and said polymeric solid electrolyte may comprise from 70 to 90:1 to 7:9 to 23 by weight.

Another aspect of the present invention provides a secondary cell comprising said electrodes.

Another aspect of the present invention provides an apparatus comprising said secondary cell, wherein said apparatus is selected from the group consisting of a communication device, an energy storage system (ESS), and a transportation vehicle.

Another aspect of the present invention provides a method of preparing a solvent-free polymeric solid electrolyte comprising: (A) mixing a liquid monomer and an excess of lithium salt to obtain a solvent-free composition for preparing a polymeric solid electrolyte; and (B) crosslinking said polymeric solid electrolyte composition.

With respect to said 100 parts by weight of liquid monomer, said lithium salt may be from 120 to 350 parts by weight.

The liquid monomer may comprise one or more functional groups selected from the group consisting of carbonyl groups, amine groups, epoxy groups, phenolic groups, urethane groups, and acrylate groups.

Examples of the above lithium salts include but are not limited to at least one selected from LiBOB, LiFOB, LiDFBP, Li(CF₃SO₂)₂, Li(CF₃SO₂)₂CH, Li(CF₃SO₂)₃C, LiCF₃(CF₂)₇SO₃, LiCF₃SO₃, LiCF₃CF₂SO₃, LiTFO, LiClO₄, LiSbF₆, LiAsF₆, LiPF₆, Li(CF₃)₂PF₄, Li(CF₃)₃PF₃, Li(CF₃)₄PF₂, Li(CF₃)5PF, Li(CF₃)₆P, LiCTFSI (LiN(C₂F₄S₂O₄)), LiBETI (LiC₄NO₄F₁₀S₂), LiFSI (LiNO₄F₂S₂) and LiTFSI (LiC₂NO₄F₆S₂).

The combination of said liquid monomer and said lithium salt (liquid monomer, lithium salt) may be at least one selected from the group consisting of (bisphenol A, LiBETI), (bisphenol F, LiFSI), (polyester polyol, LiTFSI), (Novalak, LiFSI), (polyether polyol, LiBETI), and (acrylic acid, LiTFSI).

The crosslinking may be performed by heat treatment or UV irradiation.

Said crosslinking may be carried out by heat treatment at 50 to 90° C. for 0.8 to 4 hours.

The crosslinking may be performed by irradiating with UV for 0.5 to 6 minutes.

The solvent-free composition for making a polymeric solid electrolyte further comprises a photoinitiator, said photoinitiator being selected from 2-hydroxy-2-methylpropiophenone (HMPP), 2,4,6-trimethyl benzoyl diphenyl phosphine (TPO), and benzildimethylketal (BDK), the photoinitiator may be at least one selected from the group consisting of 2-hydroxy-2-methylpropiophenone (HMPP), 2,4, 6-trimethyl benzoyl diphenyl phosphine (TPO), and benzildimethylketal (BDK).

The solvent-free composition for making said polymeric solid electrolyte may further comprise from 1.3 to 2 parts by weight of a photoinitiator, based on a total of 100 parts by weight of said liquid monomer and said lithium salt.

Another aspect of the present invention provides a method of preparing an electrode, comprising (I) mixing a liquid monomer and an excess of lithium salt to obtain a solvent-free composition for preparing a polymeric solid electrolyte; (II) mixing an electrode active material and said polymeric solid electrolyte solvent-free composition to prepare an electrode slurry; and (III) crosslinking said electrode slurry to prepare an electrode.

### Effect of Invention

The polymer electrolyte compositions according to the present invention can exhibit good dispersibility without the need for process solvents, and can solve the problems caused by the residual solvent.

Furthermore, the polymer electrolyte compositions of the present invention can exhibit high oxidative stability due to their high concentration electrolyte properties, and can exhibit wide potential window properties.

Furthermore, the polymer electrolyte of the present invention can exhibit high adhesion to the collector due to strong intermolecular interactions.

The effects of the present invention are not limited to those mentioned above. The effects of the invention are to be understood to include all effects that can be inferred from the following description.

### BRIEF DESCRIPTION OF THE DRAWINGS

### Short Description of the Drawing

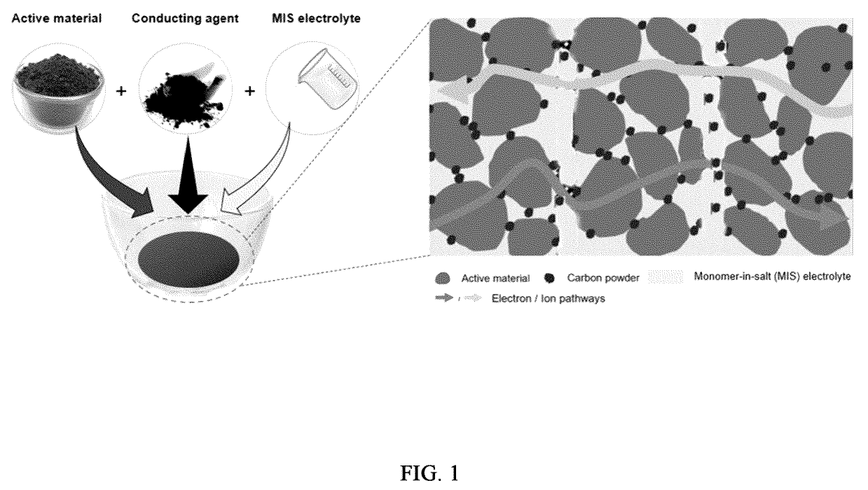

FIG. 1 illustrates a method of fabrication and a schematic diagram of an electrode according to one embodiment of the present invention.

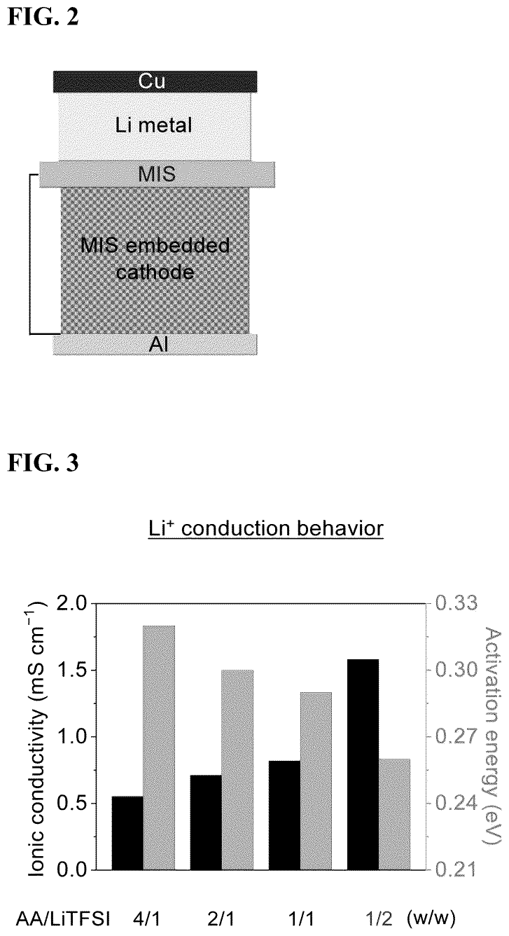

FIG. 2 is a simplified schematic illustration of an electrode fabricated in an Example of the present invention.

FIG. 3 shows the ionic conductivity and activation energy of the polymer-based electrolytes prepared in Example 1 (1/2), Comparative Example 1 (4/1), Comparative Example 2 (2/1), and Comparative Example 3 (1/1) of the present invention.

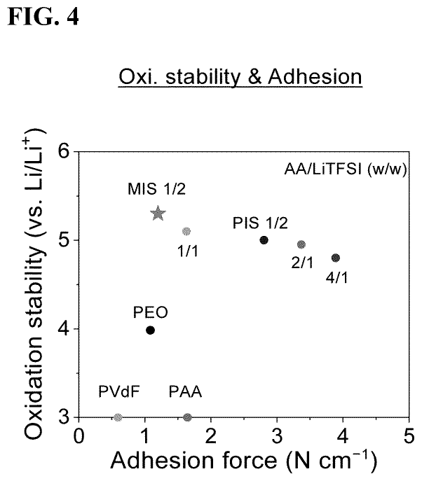

FIG. 4 shows the results of the oxidation stability and adhesion force evaluations of the polymer electrolyte and electrodes prepared in Example 1 (MIS, 1/2), Comparative Example 1 (4/1), Comparative Example 2 (2/1), Comparative Example 3 (1/1), and Comparative Example 4 (PIS) of the present invention and the electrodes using PEO, PVdF, and PAA.

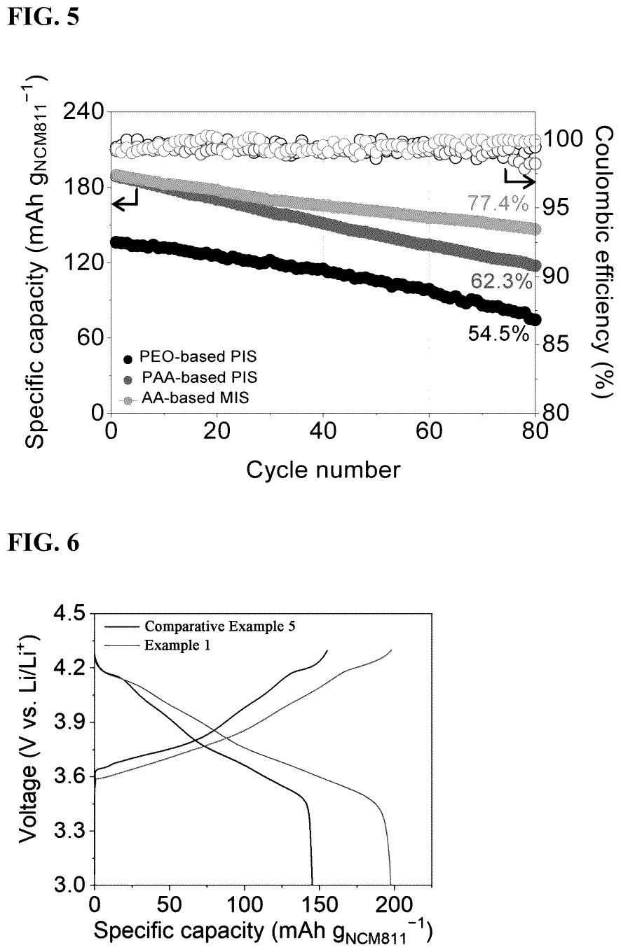

FIG. 5 shows the specific capacity and coulombic efficiency as a function of the number of cycles of the electrode prepared in Example 1 (AA-based MIS) and Comparative Example 4 (PAA-based PIS) of the present invention and the electrode utilizing PEO as a polymeric or polymer-based electrolyte (PEO-based PIS).

FIG. 6 shows the results of the electrochemical characterization of the electrodes prepared in Example 1 and Comparative Example 5 of the present invention.

### SPECIFIC DETAILS FOR PRACTICING THE INVENTION

The advantages and features of the present invention, and methods of achieving them, will become apparent upon reference to the embodiments described in detail with reference to the accompanying drawings. However, the invention is not limited to the embodiments disclosed herein, but will be embodied in many different forms, and these embodiments are provided merely to make the disclosure of the invention complete and to give a complete picture of the scope of the invention to those having ordinary skill in the art to which the invention belongs, and the invention is defined by the scope of the claims.

Further, the terms “comprising” or “having” and the like are intended to designate the presence of the features, numbers, steps, components, or combinations thereof described, and not to be construed as excluding the possibility of the presence or addition of one or more other features, numbers, steps, components, or combinations thereof. Further, where components are expressed in the singular, they include the plural unless otherwise expressly indicated.

The invention will now be described in more detail below.

As mentioned above, liquid electrolytes are prone to internal pressure increase and leakage, which can lead to short circuits if the separator is damaged by deformation or external impact, or even worse, overheating or explosion. Solid electrolytes were developed as an alternative, but solid electrolytes have low ionic conductivity, high interfacial resistance, resulting in poor output and capacity characteristics, and are not economical in terms of manufacturing processes.

Accordingly, the present invention provides a solvent-free polymer electrolyte composition comprising a liquid monomer; and a lithium salt, wherein said lithium salt is included in an excess amount over said liquid monomer, and improves ionic conductivity and electrochemical properties without suffering from any stability problems seen in liquid electrolytes, while also reducing cost and time in terms of manufacturing process.

More specifically, one aspect of the present invention provides a solvent-free composition for making a polymeric solid electrolyte comprising a liquid monomer; and a lithium salt, wherein said lithium salt is included in an excess amount over said liquid monomer.

The polymer electrolyte composition according to the present invention is wherein it comprises a liquid monomer and a lithium salt, wherein said lithium salt is in excess of said liquid monomer and is solvent-free, so that it can exhibit excellent oxidation stability with wide potential window characteristics. If any of the above technical features of the present invention are not satisfied, the oxidation stability may be reduced, and the narrow potential window may cause decomposition during long-term operation at high voltage, making it unsuitable for use as a polymer electrolyte.

In particular, the polymer electrolyte composition of the present invention is characterized by being solvent-free, which can increase process economy by omitting the injection and wetting processes required in liquid electrolytes that use solvents. Furthermore, the polymer electrolyte composition exhibits high dispersibility despite the absence of solvent, and since there is no residual solvent even after the polymer electrolyte is prepared, there is no side reaction or structural decay of the electrode material when used on the electrode.

The liquid monomer refers to a monomer having a melting point (M.P.) at room temperature or higher at normal pressure, and by using the liquid monomer, it is possible to prepare a solvent-free polymer electrolyte composition, and the ionic conductivity is significantly improved by increasing the uniformity inside the polymer electrolyte composition and inside the electrode despite being solvent-free.

Furthermore, the polymer-based electrolyte composition of the invention is wherein said lithium salt is included in an excess amount over said liquid monomer, wherein an excess amount means that said lithium salt is included in a greater weight relative to said liquid monomer.

More specifically, with respect to said 100 parts by weight of liquid monomer, said lithium salt may comprise from 120 to 350 parts by weight, preferably from 130 to 300 parts by weight, more preferably from 150 to 250 parts by weight, and most preferably from 180 to 220 parts by weight.

If the weight ratio of the above lithium salt to the above liquid monomer 100 weight part is less than the above lower limit, the potential window of the polymer electrolyte utilizing the lithium salt is not wide enough, and it may be difficult to expect high efficiency in high-voltage operation; on the other hand, if the above upper limit is exceeded, the lithium salt may not dissociate, and it may be difficult to play a role as an electrolyte, and the adhesion may deteriorate rapidly.

The liquid monomer may comprise at least one functional group selected from the group consisting of carbonyl groups, amine groups, epoxy, phenolic, urethane and acrylate groups, preferably at least one functional group selected from the group consisting of epoxy, phenolic, urethane and acrylate groups, more preferably at least one functional group selected from the group consisting of carboxyl groups in the acrylate series, and most preferably the liquid monomer may be acrylic acid.

Specific examples of liquid monomers containing epoxy groups include Bisphenol A, Bisphenol F, Novalac, and Glycidyl Amine.

Specific examples of liquid monomers containing phenolic groups include Novolak and Resol.

Specific examples of liquid monomers containing urethane groups include polyether polyols, polyester polyols, and isocyanates.

Specific examples of liquid monomers containing acrylate groups include methyl metharylate, acrylo nitrile, and acrylic acid.

If the liquid monomer contains an acrylate group, it is more durable and stable due to less change in physical properties due to hydrogen bonding between monomers due to the presence of —OH groups, lightweight due to low density, and easy to manufacture in various shapes due to increased processability. Furthermore, it is recyclable and has the advantage of being an environmentally friendly material. In particular, if the liquid monomer is acrylic acid, it is more preferable in that it exhibits better stability due to less viscosity change due to long-term storage and temperature change.

If said liquid monomer comprises urethane groups, it is preferable in that it has strong cohesion and thus excellent durability.

If the liquid monomer is a liquid monomer comprising a phenolic group, it is preferable in that it has a large retention rate of strength even when used at high temperatures for a long time and excellent flame retardancy.

Examples of the above lithium salts include but are not limited to at least one selected from LiBOB, LiFOB, LiDFBP, Li(CF₃SO₂)₂, Li(CF₃SO₂)₂CH, Li(CF₃SO₂)₃C, LiCF₃(CF₂)₇SO₃, LiCF₃SO₃, LiCF₃CF₂SO₃, LiTFO, LiClO₄, LiSbF₆, LiAsF₆, LiPF₆, Li(CF₃)₂PF₄, Li(CF₃)₃PF₃, Li(CF₃)₄PF₂, Li(CF₃)5PF, Li(CF₃)₆P, LiCTFSI (LiN(C₂F₄S₂O₄)), LiBETI (LiC₄NO₄F₁₀S₂), LiFSI (LiNO₄F₂S₂) and LiTFSI (LiC₂NO₄F₆S₂).

When said lithium salt is at least one species selected from the group consisting of LiBOB, LiFOB, and LiDFBP, it is preferred in that the SEI interface formation leading to stable lithium electrodeposition is more robustly formed, and the interface is maintained in its initial shape even under high voltage conditions.

If said lithium salt is at least one species selected from the group consisting of Li(CF₃SO₂)₂, Li(CF₃SO₂)₂CH, Li(CF₃SO₂)₃C, LiCF₃ (CF₂)₇SO₃, LiCF₃SO₃, and LiCF₃CF₂SO₃, it is preferred in that it is chemically safe and side reactions are avoided.

It is preferred if said lithium salt is at least one species selected from the group consisting of LiTFO, LiClO₄, LiSbF₆, LiAsF₆, LiPF₆, Li(CF₃)₂PF₄, Li(CF₃)₃PF₃, Li(CF₃)₄PF₂, Li(CF₃)₅PF, and Li(CF₃)₆P, in that it exhibits excellent lithium dissociation performance even when subjected to repeatedly drastic changes in temperature.

When said lithium salt is at least one selected from the group consisting of LiCTFSI (LiN(C₂F₄S₂O₄)), LiBETI (LiC₄NO₄F₁₀S₂), LiFSI (LiNO₄F₂S₂), and LiTFSI (LiC₂NO₄F₆S₂), the dissociation of the lithium salt is further induced due to the delocalization of the anionic charge, thereby improving the ionic conductivity properties and inducing the formation of a stable SEI interface based on LIF. Furthermore, when the liquid monomer is a monomer comprising an acrylate group, it is preferable in that the acrylate OH and the F of the lithium salt form a hydrogen bond, thereby significantly facilitating the dissociation of the lithium ions.

According to a preferred one embodiment of the present invention, the combination of said liquid monomer; and said lithium salt; The combination (liquid monomer, lithium salt) may be at least one selected from the group consisting of (bisphenol A, LiBETI), (bisphenol F, LiFSI), (polyester polyol, LiTFSI), (Novalak, LiFSI), (polyether polyol, LiBETI), and (acrylic acid, LiTFSI).

When the combination of said liquid monomer; and said lithium salt is (bisphenol A, LiBETI), the rate of increase of the electrode-active material interfacial layer thickness can be significantly reduced after a secondary cell comprising the same is charged and discharged at a high voltage for a long period of time.

When the combination of said liquid monomer; and said lithium salt; is (bisphenol F, LiFSI), the mechanical properties of the secondary cell comprising it may not deteriorate at all from the initial one even after prolonged charge and discharge at high voltage.

When the combination of said liquid monomer; and said lithium salt; is (polyester polyol, LiTFSI), the secondary cell comprising the same may not experience any desorption of active material from the collector even after long-term charge and discharge.

When the combination of said liquid monomer; and said lithium salt; is (polyether polyol, LiBETI), a secondary cell comprising the same may not develop cracks in the electrode active material even after long-term charge and discharge.

When the combination of said liquid monomer; and said lithium salt; is (acrylic acid, LiTFSI), even if an electrode with a large thickness is prepared and utilized in a secondary cell using the same, the amount of decrease in capacity expression of the secondary cell comprising said electrode can be alleviated because the ion network is well formed.

Another aspect of the present invention provides a polymer-based electrolyte prepared by crosslinking said polymer-based electrolyte composition.

The crosslinking may be performed by heat treatment or UV irradiation.

Another aspect of the present invention provides an electrode comprising: said polymer-based electrolyte composition; and an electrode active material.

The electrode active material has a low binding capacity to the collector, making a binder essential in the manufacture of the electrode, but such a binder reduces the proportion of active material, resulting in the prior art electrodes not having high energization characteristics. The electrode of the present invention, on the other hand, provides a solvent-free composition for manufacturing a polymeric solid electrolyte comprising a liquid monomer and an excess of lithium salt, and an electrode comprising an electrode active material, thereby improving ionic conductivity and electrochemical properties without the risk of residual solvent, and enabling the electrode to exhibit high energization properties with excellent adhesion without the need for a binder.

FIG. 1 is a schematic illustration of a method of fabricating an electrode according to one embodiment of the present invention.

Referring to FIG. 1 above, it can be seen that the electrode of the present invention does not contain a binder, as the solvent-free composition for the preparation of polymer-based solid electrolytes exhibits binder properties based on high adhesion with the collector due to strong intermolecular interactions. As a result, the electrode using the solvent-free composition for preparing a polymer-based solid electrolyte according to the present invention can exhibit high energization characteristics by increasing the active material ratio due to the absence of a binder, and can exhibit eco-friendly characteristics by not using a conventional F-based binder. Furthermore, it can be seen that the polymer electrolyte composition acts as a passageway for ions in the electrode.

The electrode active material may comprise one or more species selected from the group consisting of LCO (LiCoO₂), NCM111 (LiNi_{1/3}Co_{1/3}Mn_{1/3}O₂), NCM622 (LiNi_{0.6}Co_{0.2}Mn_{0.2}O₂), NCM811 (LiNi_{0.8}Co_{0.1}Mn_{0.1}O₂), LMO (LiMn₂O₄), and LNMO (LiNi_{0.5}Mn_{1.5}O₄), most preferably may comprise NCM811 (LiNi_{0.8}Co_{0.1}Mn_{0.1}O₂).

The electrode slurry may further comprise a conductive material.

Said coating material may comprise at least one species selected from the group consisting of Super P, Super C, carbon black, Ketjenblack, natural graphite, artificial graphite, carbon black, acetylene black, lamp black, furnace black and summer black, most preferably Super P.

Based on 100 wt % of the total of said electrodes, said solvent-free polymeric solid electrolyte may comprise from 9 to 23 wt %, preferably from 12 to 22 wt %, more preferably from 14 to 21 wt %, most preferably from 15 to 20 wt %.

If the solvent-free polymeric solid electrolyte is included at a weight percentage below the lower limit, it may be difficult to fabricate a high-loading electrode, and conversely, if it is included at a weight percentage above the upper limit, the energy density may be reduced due to a decrease in the active material ratio.

Said electrode may comprise said electrode active material, said coating material and a solvent-free composition for the preparation of said polymeric solid electrolyte in a ratio of 70 to 90:1 to 7:9 to 23 parts by weight, preferably 72 to 87:1 to 6:12 to 22 parts by weight, more preferably 74 to 85:1 to 5:14 to 21 parts by weight, most preferably 76 to 83:2 to 4:15 to 20 parts by weight.

Preferably, the weight ratio of said electrode active material, said conductive material and said solvent-free composition for the preparation of said polymeric solid electrolyte in said electrode satisfies the above range, in that it is possible to fabricate an electrode for high energy density when the weight ratio of said electrode active material, said conductive material and said solvent-free composition for the preparation of said polymeric solid electrolyte satisfies the above range.

In particular, the solvent-free compositions for the preparation of polymer-based solid electrolytes according to the present invention exhibit high adhesion to the collector due to strong intermolecular interactions and thus have binder properties. As a result, electrodes using the solvent-free composition for the preparation of polymer-based solid electrolytes according to the present invention can exhibit high energization characteristics by increasing the active material ratio due to the absence of binders, and exhibit eco-friendly characteristics by not using conventional F-based binders.

Another aspect of the present invention provides a cell comprising said polymer-based electrolyte composition or said electrode.

The battery may be a secondary cell, preferably a lithium secondary cell.

Another aspect of the present invention provides an apparatus comprising said secondary cell, wherein said apparatus is selected from the group consisting of a communication device, an energy storage system (ESS), and a transportation vehicle.

Another aspect of the present invention provides a method of preparing a polymer-based electrolyte comprising (A) mixing a liquid monomer and an excess of lithium salt to obtain a solvent-free composition for preparing a polymeric solid electrolyte; and (B) crosslinking said polymer-based electrolyte composition.

### (A) Mixing a Liquid Monomer and an Excess of Lithium Salt to Obtain a Solvent-Free Composition for Making a Polymeric Solid Electrolyte

Step (A) above, wherein the liquid monomer and an excess of lithium salt are mixed to obtain a solvent-free composition for the preparation of a polymeric solid electrolyte.

In said step (A), said lithium salt is mixed in excess of said liquid monomer.

For said 100 parts by weight of liquid monomer, said lithium salt may be mixed in an amount of from 120 to 350 parts by weight, preferably from 130 to 300 parts by weight, more preferably from 150 to 250 parts by weight, and most preferably from 180 to 220 parts by weight.

If the weight ratio of the above lithium salt to the above liquid monomer 100 parts by weight is less than the above lower limit, the potential window of the polymer electrolyte finally prepared may not be wide enough, and it may be difficult to expect high efficiency in high-voltage operation; conversely, if the above upper limit is exceeded, the lithium salt may not dissociate and cannot be expected to act as an electrolyte.

The liquid monomer may comprise at least one functional group selected from the group consisting of carbonyl groups, amine groups, epoxy, phenolic, urethane and acrylate groups, preferably at least one functional group selected from the group consisting of epoxy, phenolic, urethane and acrylate groups, more preferably at least one functional group selected from the group consisting of carboxyl groups in the acrylate series, and most preferably the liquid monomer may be acrylic acid.

Examples of the above lithium salts include but are not limited to at least one selected from LiBOB, LiFOB, LiDFBP, Li(CF₃SO₂)₂, Li(CF₃SO₂)₂CH, Li(CF₃SO₂)₃C, LiCF₃(CF₂)₇SO₃, LiCF₃SO₃, LiCF₃CF₂SO₃, LiTFO, LiClO₄, LiSbF₆, LiAsF₆, LiPF₆, Li(CF₃)₂PF₄, Li(CF₃)₃PF₃, Li(CF₃)₄PF₂, Li(CF₃)5PF, Li(CF₃)₆P, LiCTFSI (LiN(C₂F₄S₂O₄)), LiBETI (LiC₄NO₄F₁₀S₂), LiFSI (LiNO₄F₂S₂) and LiTFSI (LiC₂NO₄F₆S₂).

According to a preferred one embodiment of the present invention, the combination of said liquid monomer; and said lithium salt; The combination (liquid monomer, lithium salt) may be at least one selected from the group consisting of (bisphenol A, LiBETI), (bisphenol F, LiFSI), (polyester polyol, LiTFSI), (Novalak, LiFSI), (polyether polyol, LiBETI), and (acrylic acid, LiTFSI).

### (B) Crosslinking Said Polymer-Based Electrolyte Composition;

The step (B) wherein said polymer-based electrolyte composition is crosslinked to produce a polymer-based electrolyte.

The crosslinking may be performed by heat treatment or UV irradiation.

Said heat treatment may be carried out at 50 to 90° C. for 0.8 to 4 hours, preferably at 55 to 85° C. for 1 to 3 hours, more preferably at 57 to 82° C. for 1.5 to 2.5 hours, most preferably at 60 to 80° C. for 1.8 to 2.3 hours.

If any of the above heat treatment temperatures and times are below the lower limit, thick film electrode fabrication may be difficult, and conversely, if they are above the upper limit, degradation of the components in the electrode may occur.

Said UV irradiation may be performed by irradiating with UV for 0.1 to 6 minutes, preferably 0.2 to 3 minutes, more preferably 0.3 to 2.5 minutes, most preferably 0.5 to 1.5 minutes.

If the UV irradiation time is less than the lower limit of 0.1 minutes, not enough cross-linking may occur, and if the upper limit of 6 minutes is exceeded, cross-linking may be complete and no further cross-linking may occur, which will only increase the cost.

Where said crosslinking is performed by UV irradiation, said solvent-free composition for the preparation of a polymeric solid electrolyte may further comprise a photoinitiator.

The photoinitiator may be one or more selected from the group consisting of 2-hydroxy-2-methylpropiophenone (HMPP), 2,4,6-trimethyl benzoyl diphenyl phosphine (TPO), and benzildimethylketal (BDK).

Said photoinitiator may be 1.3 to 2 parts by weight, preferably 1.5 to 1.8 parts by weight, more preferably 1.6 to 1.7 parts by weight, most preferably 1.64 to 1.68 parts by weight, based on a total of 100 parts by weight of said liquid monomer and said lithium salt.

If said photoinitiator is less than said lower limit with respect to a total of 100 parts by weight of said liquid monomer and said lithium salt, crosslinking may not occur sufficiently, and if it is more than said upper limit, crosslinking may be complete and no further crosslinking may occur, which only increases the cost.

Another aspect of the present invention provides a method of preparing an electrode, comprising (I) mixing a liquid monomer and an excess of lithium salt to obtain a solvent-free composition for preparing a polymeric solid electrolyte; (II) mixing an electrode active material and said polymeric solid electrolyte solvent-free composition to prepare an electrode slurry; and (III) crosslinking said electrode slurry to prepare an electrode.

In the manufacturing method of the electrode of the present invention, the contents of the polymer electrolyte composition which are deemed to be the same as those described above are omitted from the following detailed description.

For said 100 parts by weight of liquid monomer, said lithium salt may be mixed in an amount of from 120 to 350 parts by weight, preferably from 130 to 300 parts by weight, more preferably from 150 to 250 parts by weight, most preferably from 180 to 220 parts by weight.

The liquid monomer may comprise at least one functional group selected from the group consisting of carbonyl groups, amine groups, epoxy, phenolic, urethane and acrylate groups, preferably at least one functional group selected from the group consisting of epoxy, phenolic, urethane and acrylate groups, more preferably at least one functional group selected from the group consisting of carboxyl groups in the acrylate series, and most preferably the liquid monomer may be acrylic acid.

Examples of the above lithium salts include but are not limited to LiBOB, LiFOB, LiDFBP, Li(CF₃SO₂)₂, Li(CF₃SO₂)₂CH, Li(CF₃SO₂)₃C, LiCF₃(CF₂)₇SO₃, LiCF₃SO₃, LiCF₃CF₂SO₃, LiTFO, LiClO₄, LiSbF₆, LiAsF₆, LiPF₆, Li(CF₃)₂PF₄, Li(CF₃)₃PF₃, Li(CF₃)₄PF₂, Li(CF₃)5PF, Li(CF₃)₆P, LiCTFSI (LiN(C₂F₄S₂O₄)), LiBETI (LiC₄NO₄F₁₀S₂), LiFSI (LiNO₄F₂S₂), and LiTFSI (LiC₂NO₄F₆S₂).

According to a preferred one embodiment of the present invention, the combination of said liquid monomer; and said lithium salt; The combination (liquid monomer, lithium salt) may be at least one selected from the group consisting of (bisphenol A, LiBETI), (bisphenol F, LiFSI), (polyester polyol, LiTFSI), (Novalak, LiFSI), (polyether polyol, LiBETI), and (acrylic acid, LiTFSI).

The electrode active material may comprise one or more species selected from the group consisting of LCO (LiCoO₂), NCM111 (LiNi_{1/3}Co_{1/3}Mn_{1/3}O₂), NCM622 (LiNi_{0.6}Co_{0.2}Mn_{0.2}O₂), NCM811 (LiNi_{0.8}Co_{0.1}Mn_{0.1}O₂), LMO (LiMn₂O₄) [symbol] LNMO (LiNi_{0.5}Mn_{1.}5O₄), most preferably NCM811 NCM811 (LiNi_{0.8}Co_{0.1}Mn_{0.1}O₂).

The electrode slurry may further comprise a conductive material.

Said coating material may comprise at least one species selected from the group consisting of Super P, Super C, carbon black, Ketjenblack, natural graphite, artificial graphite, carbon black, acetylene black, lamp black, furnace black and summer black, most preferably Super P.

Based on a total of 100 wt % of said electrode slurry, said solvent-free composition for the preparation of a polymeric solid electrolyte may comprise from 9 to 23 wt %, preferably from 12 to 22 wt %, more preferably from 14 to 21 wt %, most preferably from 15 to 20 wt %.

If the solvent-free composition for the preparation of the polymeric solid electrolyte is included in a weight percentage below the lower limit, it may be difficult to fabricate a dry thick film electrode for high energization, and conversely, if it is included in a weight percentage above the upper limit, a decrease in energy density may occur due to a decrease in the proportion of active material.

Said electrode slurry may comprise said electrode active material, said coating material and a solvent-free composition for the preparation of said polymeric solid electrolyte in a ratio of 70 to 90:1 to 7:9 to 23 parts by weight, preferably 72 to 87:1 to 6:12 to 22 parts by weight, more preferably 74 to 85:1 to 5:14 to 21 parts by weight, most preferably 76 to 83:2 to 4:15 to 20 parts by weight.

Preferably, said electrode slurry satisfies the above range, in that if the weight ratio of said electrode active material, said conductive material and said solvent-free composition for making said polymeric solid electrolyte satisfies the above range, dry thick film electrode fabrication for high energization is possible.

The crosslinking in step (III) above may be performed by heat treatment or UV irradiation.

Said heat treatment may be carried out at 50 to 90° C. for 0.8 to 4 hours, preferably at 55 to 85° C. for 1 to 3 hours, more preferably at 57 to 82° C. for 1.5 to 2.5 hours, most preferably at 60 to 80° C. for 1.8 to 2.2 hours.

When the cross-linking of (III) above is performed by heat treatment, if any of the heat treatment temperature and time is below the lower limit of the above, it may be difficult to produce a thick film electrode, and conversely, if the upper limit of the above is exceeded, decomposition of the components in the electrode may occur.

The present invention will be described in more detail below by way of examples, and the scope and content of the present invention should not be construed to be reduced or limited by the following examples.

### Example 1 (Monomer+Excess Lithium Salt+Solvent-Free, MIS)

### Preparation of Polymer Electrolyte

Without using a solvent, a solvent-free composition for the preparation of a polymer-based solid electrolyte was prepared by mixing a monomer (acrylic acid, Formula 1) and a lithium salt (LiTFSI, lithium bis(trifluoromethanesulfonyl)imide, Formula 2) in a 1:2 weight ratio and adding a photoinitiator 2-Hydroxy-2-methylpropiophenon (HMPP) in an amount equal to 0.05 weight of the monomer. The polymeric solid electrolyte composition in solution was then cast onto a nonwoven fabric surface. Then, the polymer electrolyte composition coated on the nonwoven fabric was subjected to UV (365 nm, 2000 mW/cm²) crosslinking for 1 minute to polymerize the crosslinking monomer to prepare the polymer electrolyte.

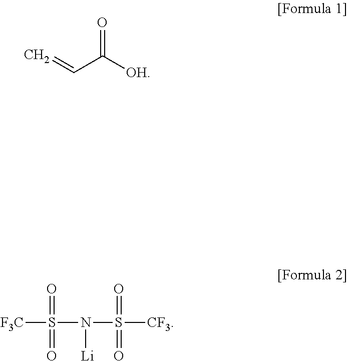

### Electrode Manufacturing

An electrode slurry was prepared by mixing the cathode active material (NCM811, LLO)/coating material (Super P)/solvent-free composition for the preparation of the above polymer-based solid electrolyte in a weight ratio of 80:3:17. Then, the electrode slurry was cast onto the Al electrode, and the electrode was prepared by thermal crosslinking at 70° C. for 2 hours.

FIG. 2 is a simplified schematic illustration of an electrode fabricated in an Example of the present invention.

Referring to FIG. 2 above, an electrode comprising the solvent-free polymeric solid electrolyte (MIS) composition was formed on the Al electrode.

### Example 2

The molecular electrolyte and electrode were prepared as in Example 1 above, except that the monomer and lithium salt were mixed in a weight ratio of 1:1.4.

### Example 3

The molecular electrolyte and electrode were prepared as in Example 1 above, except that the monomer and lithium salt were mixed in a weight ratio of 1:4.

### Comparative Examples 1 to 3 (Excess Monomer+Lithium Salt+Solvent-Free)

The polymer electrolyte and electrode were prepared as in Example 1 above, except that the monomer (acrylic acid) and lithium salt (LiTFSI) were changed to 4:1 (Comparative Example 1), 2:1 (Comparative Example 2), and 1:1 (Comparative Example 3).

### Comparative Example 4 (Polymer+Excess Lithium Salt+Solvent-Free, PIS)

The polymer electrolyte and electrode were prepared as in Example 1 above, but using poly-Acrylic acid rather than acrylic acid monomer.

### Comparative Example 5 (Monomer+Excess Lithium Salt+Solvent)

The polymer electrolyte and electrode were prepared as in Example 1 above, except that the polymer electrolyte and electrode were prepared by including 10 parts by weight of N,N-Dimethylformamide (DMF) as a solvent for a total of 100 parts by weight of the polymer electrolyte composition.

### Example 1. Evaluation of Lithium Ion Conduction Performance as a Function of Monomer and Lithium Salt Mix Ratio

The ionic conductivity of the polymer electrolytes prepared in Example 1 and Comparative Examples 1 to 3 above was evaluated, and the results are shown in FIG. 3.

FIG. 3 shows the ionic conductivity and activation energy of the polymer-based electrolytes prepared in Example 1 (1/2), Comparative Example 1 (4/1), Comparative Example 2 (2/1), and Comparative Example 3 (1/1) of the present invention.

Referring to FIG. 3 above, it can be seen that the ionic conductivity of Example 1 (1/2), Comparative Example 1 (4/1), Comparative Example 2 (2/1), and Comparative Example 3 (1/1) is 0.158. 0.0552, 0.0711, and 0.0819 mS/cm, respectively, at 60 degrees C., indicating that the ionic conductivity is significantly improved in the polymer electrolyte of the present invention. Furthermore, the activation energies for the lithium conduction behavior of Example 1 (1/2), Comparative Example 1 (4/1), Comparative Example 2 (2/1), and Comparative Example 3 (1/1) are 0.25, 0.32, 0.3, and 0.29 eV, respectively, indicating that the lithium conduction behavior is significantly improved in the polymer electrolyte of the present invention.

### Example 2. Evaluation of Lithium Ion Conduction Performance as a Function of Monomer and Lithium Salt Mix Ratio

The adhesion and oxidation stability of the polymer-based electrolytes and electrodes prepared in Example 1 and Comparative Examples 1 to 4 above were evaluated, and the results are shown in FIG. 4 and Table 1 below.

In FIG. 4 above and Table 1 below, PEO, PVdF, and PAA are used as polymer-based electrolytes, respectively.

The adhesion was evaluated by the peel-off test method.

The oxidation stability was evaluated by the linear sweep voltammetry (LSV) method.

FIG. 4 shows the results of the oxidation stability and adhesion force evaluations of the polymer electrolyte and electrodes prepared in Example 1 (MIS, 1/2), Comparative Example 1 (4/1), Comparative Example 2 (2/1), Comparative Example 3 (1/1), and Comparative Example 4 (PIS) of the present invention and the electrodes using PEG, PVdF, and PAA.

TABLE 1

| | Oxidation Stability | Adhesion |
|---|---|---|
| Separation | (vs Li/Li)⁺ | (N cm)⁻¹ |
| Example 1 (MIS, 1/2) | 5.3 | 0.53 |
| Comparative Example 1 | 4.8 | 0.91 |
| (4 of 1) | | |
| Comparative Example 2 (2/1) | 4.95 | 0.77 |
| Comparative Example 3 (1/1) | 5.1 | 0.55 |
| Comparative Example 4 (PIS) | 5 | 0.33 |
| PEO | 4.52 | 0.29 |
| PVdF | —. | 0.53 |
| PAA | —. | 1.63 |

Referring to FIG. 4 and Table 1 above, it can be seen that the polymer-based electrolyte (MIS, 1/2) prepared in Example 1 of the present invention exhibits excellent oxidation stability compared to Comparative Examples 1 to 4, which have a small or equal amount of lithium salt compared to the monomer, Comparative Example 4, which uses a polymer rather than a monomer, and PEG, PVdF, and PAA used as conventional polymer-based electrolytes, and exhibits adhesion comparable to PVdF.

### Example 3. Evaluation of Li-Ion Conduction Performance

The electrodes prepared in Example 1 (AA-based MIS) and Comparative Example 4 (PAA-based PIS) and the electrode using PEG as a polymer-based electrolyte (PEG-based PIS) were prepared under the following conditions and their electrochemical properties were evaluated, and are shown in FIG. 5.
Areal mass loading: 40 mg cm⁻²
MIS=AA/LiTFSI=1/2 (w/w)
Electrode density: 3.2 g cm⁻³
NCM811/Super P/MIS=80/3/17 (w/w/w)
Cut-off voltage: 3.0-4.3 V
Operating temp.: 60° C.

FIG. 5 shows the specific capacity and coulombic efficiency as a function of the number of cycles of the electrode prepared in Example 1 (AA-based MIS) and Comparative Example 4 (PAA-based PIS) of the present invention and the electrode utilizing PEO as a polymer-based electrolyte (PEO-based PIS).

Referring to FIG. 5 above, it can be seen that the electrode prepared in Example 1 of the present invention (AA-based MIS) maintained 77.4% of the initial amount of cost even after 80 cycles compared to the electrode prepared in Comparative Example 4 (PAA-based PIS) and the electrode utilizing PEO as a polymer-based electrolyte (PEO-based PIS), showing excellent capacity retention and cycle characteristics.

Furthermore, it was confirmed that the electrode prepared in Example 1 (AA-based MIS) of the present invention maintained the highest Coulombic efficiency in the present invention with 77.4, 54.5, and 62.3% after 80 cycles compared to the electrode prepared in Comparative Example 4 (PAA-based PIS) and the electrode using PEO as the polymer-based electrolyte (PEO-based PIS), respectively.

### Example 4. Evaluation of Storage Characteristics

Using the electrodes prepared in Examples 1 to 3 and Comparative Examples 1 to 3 above, the cells were prepared under the same conditions as in Experimental Example 3 above, and charge and discharge measurements were made between 3.0 and 4.2 V at a constant current density of 5.0 mA/cm². At this time, the discharge capacity before storage (60° C.) was measured, and the cell was charged to 4.2 V at a constant current density of 5.0 mA/cm² for 8 hours. After the charged test cell was stored for 20 days in a chamber adjusted to maintain 80° C., the discharge capacity (60° C.) was measured between 3.0 and 4.2 V at a constant current density of 5.0 mA/cm², and the storage characteristics (%) were calculated as shown in Equation (1) below, and the results are shown in Table 2.

$$Equation ( 1 )$$

$$( Discharge capacity after storage ) / ( Discharge capacity before storage ) * 100$$

TABLE 2

| Separation | Storage attributes (%) |
|---|---|
| Example 1 | 98.2 |
| Example 2 | 95.5 |
| Example 3 | 94.2 |
| Comparative Example 1 | 89.54 |
| Comparative Example 2 | 91.38 |
| Comparative Example 3 | 92.37 |

As shown in Table 2 above, it can be seen that Comparative Examples 1 to 3 with an excess of liquid monomer have lower storage properties and therefore lower stability compared to Examples 1 to 3.

In particular, the storage property was increased when the weight ratio of lithium salt to liquid monomer was 2 (Example 1) compared to 1.4 (Example 2), but the storage property was decreased in Example 3 when the weight ratio of lithium salt to liquid monomer was further increased to 4, confirming that controlling the content of lithium salt to a certain range is an important factor to further improve the storage property.

### Example 5. Evaluation of Electrode Thickness Variation

Using the electrodes prepared in Examples 1 to 3 above, the cells were prepared under the same conditions as in Experimental Example 3 above, and the charging range was set such that the state of charge (SOC) ranged from 0 to 95% at 60° C., and the first cycle was charged at 0.1 C, the second cycle at 0.2 C, and the third cycle at 0.5 C from the third cycle to the 30th cycle. The change in electrode thickness from the initial state was then measured and expressed as a percentage in Table 3 below.

TABLE 3

| Separation | Electrode Thickness Change (%) |
|---|---|
| Example 1 | 15.2 |
| Example 2 | 14.7 |
| Example 3 | 21.6 |

Referring to Table 3 above, it can be seen that the electrodes prepared in Examples 1 and 2 had a small thickness variation, while the electrodes prepared in Example 3 had an increased thickness variation.

### Example 6. Temperature Rise During Overcharge

Using the electrodes prepared in Examples 1 to 3 and Comparative Examples 1 to 3 above, a battery was prepared under the same conditions as in Experimental Example 3 above, and a thermocouple was attached to the outer surface of the battery case. Then, after stabilizing the battery in a 25° C. constant temperature bath, the highest attained temperature of the battery when a constant current charge was applied until the battery voltage was 5.1 V (overcharged state) was recorded, and the temperature increase (° C.) from 25° C. was calculated. Then. The values calculated using the temperature rise of the battery using the electrode of Example 1 above as a reference (100%) are shown in Table 3 below.

TABLE 4

| | Temperature rise on |
|---|---|
| Separation | overcharge (%) |
| Example 1 | 100 |
| Example 2 | 128 |
| Example 3 | 98 |
| Comparative Example 1 | 141 |
| Comparative Example 2 | 138 |
| Comparative Example 3 | 135 |

As shown in Table 4 above, it can be seen that the embodiments using an excess of lithium salts have a lower rate of temperature increase compared to Comparative Examples 1 to 3 using an excess of monomer.

In addition, the temperature rise rate was lower in Example 1 and Example 3, and the effectiveness of suppressing the temperature rise in the case of overcharging was higher, and by comparing the results of Example 1 to 3 above, it can be seen that even if the ratio of lithium salt to monomer is excessive, there is a difference in the temperature rise rate depending on the specific weight ratio.

### Example 7

Using the electrodes prepared in Example 1 and Comparative Example 5 above, the electrochemical properties were evaluated in the same way as in Experimental Example 3 above, and the results are shown in FIG. 6.

FIG. 6 shows the results of the electrochemical characterization of the electrodes prepared in Example 1 and Comparative Example 5 of the present invention.

As shown in FIG. 6 above, the initial capacity of the electrode prepared in Example 1 is 197.7 mAh g⁻¹, while the initial capacity of the electrode prepared in Comparative Example 5 is 145.2 mAh g⁻¹, and the capacity of the electrode prepared in Comparative Example 5 is significantly lower, which is due to the induction of pores and inhomogeneity in the electrode during the drying process of DMF as solvent.

What is claimed is:

1. A solvent-free composition for preparing a polymer-based solid electrolyte, which composition comprises a liquid monomer and a lithium salt, wherein said lithium salt is comprised from 120 to 350 parts by weight based on 100 parts by weight of said liquid monomer.

2. The solvent-free composition for preparing a polymeric solid electrolyte of claim 1, wherein said liquid monomer comprises at least one functional group selected from the group consisting of carbonyl groups, amine groups, epoxy groups, phenolic groups, urethane groups, and acrylate groups.

3. The solvent-free composition for preparing a polymeric solid electrolyte of claim 1, wherein the combination of said liquid monomer and said lithium salt is selected from the group consisting of (bisphenol A, LiBETI), (bisphenol F, LiFSI), (polyester polyol, LiTFSI), (Novalak, LiFSI), (polyether polyol, LiBETI), (acrylic acid, LiTFSI), and mixtures of two or more thereof.

4. A polymer-based electrolyte prepared by crosslinking the solvent-free composition for preparing a polymeric solid electrolyte of claim 1.

5. A solvent-free composition for preparing a cathode, which comprises a liquid monomer, lithium salt, cathode active material, and a coating material, wherein said lithium salt comprises from 120 to 350 parts by weight of said liquid monomer relative to 100 parts by weight of said lithium salt.

6. The solvent-free composition for preparing cathodes of claim 5, wherein said liquid monomer comprises at least one functional group selected from the group consisting of carbonyl groups, amine groups, epoxy groups, phenolic groups, urethane groups, and acrylate groups.

7. The solvent for preparing cathode of claim 5, wherein the combination of said liquid monomer and said lithium salt, is selected from the group consisting of (bisphenol A, LiBETI), (bisphenol F, LiFSI), (polyester polyol, LiTFSI), (Novalak, LiFSI), (polyether polyol, LiBETI), (acrylic acid, LiTFSI), and mixtures of two or more thereof.

8. A cathode prepared by crosslinking a solvent-free composition for making a cathode according to claim 5.

9. A secondary cell comprising (a) a polymer-based electrolyte of claim 4, (b) a cathode prepared by crosslinking a solvent-free composition comprising a liquid monomer, lithium salt, cathode active material, and a coating material, wherein said lithium salt comprises from 120 to 350 parts by weight of said liquid monomer relative to 100 parts by weight of said lithium salt, or (c) both.

10. A process of preparing a polymer-based electrolyte, the process comprising:
(A) obtaining a solvent-free composition for preparing a polymeric solid electrolyte, the composition comprising a liquid monomer and a lithium salt; and
(B) crosslinking said liquid monomer,
wherein said lithium salt is from 120 to 350 parts by weight relative to said liquid monomer of 100 parts by weight.

11. The process of preparing the polymer-based electrolyte of claim 10, wherein said liquid monomer comprises at least one functional group selected from the group consisting of carbonyl groups, amine groups, epoxy groups, phenolic groups, urethane groups, and acrylate groups.

12. The process of preparing a polymer-based electrolyte of claim 10, wherein the combination of said liquid monomer and said lithium salt is any one of (bisphenol A, LiFSI), (bisphenol F, LiFSI), (polyester polyol, LiTFSI), (Novalak, LiFSI), (polyether polyol, LiBETI), and (acrylic acid, LiTFSI).

13. A process of preparing a cathode, the process comprising:
(A) obtaining a solvent-free composition for preparing cathodes, the composition comprising a liquid monomer, a lithium salt, a cathode active material, and a coating material;
(B) coating said composition onto a substrate; and
(C) crosslinking said composition,
wherein said lithium salt is from 120 to 350 parts by weight relative to said liquid monomer of 100 parts by weight.

14. The process of claim 13, wherein said liquid monomer comprises at least one functional group selected from the group consisting of carbonyl groups, amine groups, epoxy groups, phenolic groups, urethane groups, and acrylate groups.

15. The process of claim 13, wherein the combination of said liquid monomer and said lithium salt is any one of (bisphenol A, LiFSI), (bisphenol F, LiFSI), (polyester polyol, LiTFSI), (Novalak, LiFSI), (polyether polyol, LiBETI), and (acrylic acid, LiTFSI).
